(19) United States
(12) Patent Application Publication
(10) Pub. No.: US 2014/0353451 A1
(43) Pub. Date: Dec. 4, 2014

(54) PIVOT ARM STAND FOR DIGITAL MICROSCOPES

(71) Applicant: Carl Zeiss Microscopy GmbH, Jena (DE)

(72) Inventors: Detlef HEIN, Gottingen (DE); Heino HEISE, Adelebsen (DE)

(21) Appl. No.: 14/248,604

(22) Filed: Apr. 9, 2014

(30) Foreign Application Priority Data
Apr. 9, 2013 (DE) 10 2013 005 999.2

(51) Int. Cl. F16M 11/10; G02B 21/26; F16C 11/10

(52) U.S. Cl. CPC F16M 11/10; F16C 11/10; G02B 21/26
USPC 248/371

(57) ABSTRACT

The invention relates to a pivot arm stand for digital microscopes having a pivot arm which is pivotable about a rotation axis.

According to the invention the pivotal movement may be blocked by a high torque magnetic brake arranged about a rotation axis (DA), which consists of a simultaneously pivoting part (MS) and a fixed part (ML), whereby the blocking may be suspended for the duration of a touch of a button (TS) by releasing the high torque magnetic brake, the button (TS) being arranged on the pivot arm (SA) in such a way that it can be conveniently pressed with at least one finger of the same hand which clasps an ergonomically shaped section (EB) of the pivot arm (SA), which is provided for grasping the pivot arm (SA) for setting a pivot angle (w).

The present invention relates to a pivot arm stand for digital microscopes having a pivot arm that is pivotable about a rotation axis.

In JP-2001059599-A2 and JP-2010102344-A2 by Keyence a pivot arm stand for digital microscopes is described which includes a pivot arm that is pivotable about a horizontal rotation axis. A digital microscope is characterized in that the conventional visual view through oculars in normal microscopy is missing. The image is captured by means of a camera chip or a camera, the image data may be immediately further digitally processed. The pivot arm includes an upper focusing unit which for purposes of presetting may be roughly adjusted for height along a column and clamped in position by a hand wheel. A support for a zoom body-objective-combination for focusing may be more finely positioned parallel to the aforementioned simple column guide. The aforementioned particulars relate to the vertical setting of the pivot arm, i.e., in a pivot arm pivoted about the rotation axis, the focusing movements take place at the corresponding pivot angle.

The pivot arm is fixed in position by a hand wheel which is attached to the base of the stand and with which the pivoted axis of the pivotable pivot arm may be clamped in position. To secure the vertical setting of the pivot arm, a locking bolt is inserted in a fixed hole in the base of the stand which in the vertical position of the pivot arm is aligned with another hole in the rotatable axis of the pivot arm in such a way that in the vertical position of the pivot arm the locking bolt may be pushed in completely and in that way provide a form-locking connection between the base of the stand and the rotation axis of the pivot arm. In this position, the pivot arm must then again be fixed in position via the aforementioned clamping. When the locking bolt is fully inserted, it is impossible to pivot the pivot arm, even when the clamping is loosened.

To operate the pivot arm of the solution described, it is always necessary to loosen the clamp connection using the hand wheel in order to depart the instantaneous pivot arm position, to set the desired pivot angle and to fix by way of clamping the pivot arm in the desired pivot arm position with the aid of the hand wheel.

Starting with by far the most frequently used vertical setting of the pivot arm, the locking bolt must also be removed and, if necessary, set aside. The hand wheel must be loosened, there being no safeguard against the pivot arm suddenly tipping over due to the active torque that occurs as a result of the weight and the center of gravity of the pivot arm assembly. For that reason, the pivot arm must be supported by the other hand. Once the desired pivot angle is set, this setting must be quickly secured. With the hand wheel, however, this takes considerable time. The hand wheel must be operated with one hand while the pivot arm is held in position with the other hand, which makes a rapid and precise setting virtually impossible. The process must be repeated in reverse order when pivoting the pivot arm back to the most frequently used vertical setting. A serious drawback in this case is that the locking bolt must grasped by hand again in order to be able to push it through the holes that have to be aligned with one another. Moreover, there is a clearly perceptible, relatively large fitting tolerance between the locking bolt and the two holes. In practice, this results in poor reproducibility of the vertical setting of the pivot arm, because within the fitting tolerance there is a relatively large pivoting angle range which may potentially result in the image appearing blurred at the lateral edges despite the locking bolt being fully inserted in the vertical position. The cumbersome operation requires more time and results in additional costs. The object cannot be manipulated during the pivoting process until final clamping, since the user requires both hands for the pivoting process. As a result, the object can only be manipulated before or after the pivoting process, which requires potentially further pivoting processes, since the previously set pivot angle is unsuitable for the later processing.

Based on these disadvantages, the object of the invention is to further develop a pivot arm stand for digital microscopes having a pivotable pivot arm, such that the pivot movement, including the loosening and fixing of the assembly may be executed in a simple manner, wherein this also includes the rapid reproducible locating and departing from the vertical setting of the pivot arm, and wherein each desired pivot angle may be set with sufficient accuracy. In addition, with suitable measures, it should be possible to compensate for the active torque created as a result of the weight and the center of gravity of the pivot arm assembly, wherein it must be possible to implement the entire assembly as cost-efficiently as possible due to the critical price situation in digital microscopy.

The object is achieved by a pivot arm stand of the aforementioned kind described by the features of patent claim 1. Advantageous embodiments are specified in the subclaims 2 through 16.

### BRIEF DESCRIPTION OF THE DRAWINGS

In the drawings, where like reference numerals refer to like reference in the specification:

FIG. 1a illustrates the front view of the digital microscope system as seen from the user's perspective, including the pivoting stand SST according to the invention, a control unit BE, and a control and display unit BA;

FIG. 1b shows the side view from the left of the pivoting stand SST according to the invention;

FIG. 2 shows an exemplary embodiment for the design of the mounting according to the invention, including the magnetic brake and locking assembly;

FIG. 3 shows an exemplary embodiment for the design of the locking assembly according to the invention;

FIG. 4a shows the operation by the user using the right hand RHB;

FIG. 4b shows the operation by the user using the left hand LHB;

FIG. 5a shows the rear view of the pivoting stand SST according to the invention with the pivot arm SA in the vertical setting;

FIG. 5b shows the rear view of the pivoting stand according to the invention with a pivot arm SA tilted about the instantaneous pivot angle w relative to the vertical alignment, in each case the center of gravity S of the simultaneously pivotable structure being shown, which also includes the joint part GT, the pivot arm SA, the carrier TR, the zoom body ZK with integrated lighting and camera, as well as the objective OB;

FIG. 6a shows a front view of the pivoting stand SST according to the invention, in Z-position Z1 of the motorized upper Z-guide ZMO relative to the rotation axis DA, the pivot arm SA being situated in the vertical setting and the Z-position of the motorized lower Z-guide ZMU having a value Zb<0 relative to the rotation axis DA;

FIG. 6b shows a front view of the pivoting stand SST according to the invention, in Z-position Z2 of the motorized upper Z-guide ZMO relative to the rotation axis DA, the pivot arm SA being situated in the vertical setting and the Z-position of the motorized lower Z-guide ZMU having a value Zb<0 relative to the rotation axis DA;

FIG. 6c shows a front view of the pivoting stand SST according to the invention, in Z-position Z3 of the motorized upper Z-guide ZMO relative to the rotation axis DA, the pivot arm SA being situated in the vertical setting and the Z-position of the motorized lower Z-guide ZMU having a value Zb<0 relative to the rotation axis DA;

FIG. 7a shows a front view of the pivoting stand SST according to the invention, in Z-position Z1 of the motorized upper Z-guide ZMO relative to the rotation axis DA, the pivot arm being tilted to the right by the negative marginal pivot angle GWN<0° relative to the vertical alignment, and the Z-position of the motorized lower Z-guide ZMU having a value Zb<0 relative to the rotation axis DA;

FIG. 7b shows a front view of the pivoting stand SST according to the invention, in Z-position Z2 of the motorized upper Z-guide ZMO relative to the rotation axis DA, the pivot arm being tilted to the right by the negative marginal pivot angle GWN<0° relative to the vertical alignment, and the Z-position of the motorized lower Z-guide ZMU having a value Zb<0 relative to the rotation axis DA;

FIG. 7c shows a front view of the pivoting stand SST according to the invention, in Z-position Z3 of the motorized upper Z-guide ZMO relative to the rotation axis DA, the pivot arm being tilted to the right by the negative marginal pivot angle GWN<0° relative to the vertical alignment, and the Z-position of the motorized lower Z-guide ZMU having a value Zb<0 relative to the rotation axis DA;

FIG. 8a shows a front view of the pivoting stand SST according to the invention, in Z-position Z1 of the motorized upper Z-guide ZMO relative to the rotation axis DA, the pivot arm SA being tilted to the left relative to the vertical alignment by the positive marginal pivot angle GWP and the Z-position of the motorized lower Z-guide ZMU having a value Zb<0 relative to the rotation axis DA;

FIG. 8b shows a front view of the pivoting stand SST according to the invention, in Z-position Z2 of the motorized upper Z-guide ZMO relative to the rotation axis DA, the pivot arm SA being tilted to the left relative to the vertical alignment by the positive marginal pivot angle GWP and the Z-position of the motorized lower Z-guide ZMU having a value Zb<0 relative to the rotation axis DA;

FIG. 8c shows a front view of the pivoting stand SST according to the invention, in Z-position Z3 of the motorized upper Z-guide ZMO relative to the rotation axis DA, the pivot arm SA being tilted to the left relative to the vertical alignment by the positive marginal pivot angle GWP and the Z-position of the motorized lower Z-guide ZMU having a value Zb<0 relative to the rotation axis DA;

FIG. 9a shows a front view of the pivoting stand SST according to the invention, in Z-position Za of the motorized lower Z-guide ZMU relative to the rotation axis DA, the pivot arm SA being situated in the vertical setting and the Z-position of the motorized upper Z-guide ZMO having a value Z2 relative to the rotation axis DA;

FIG. 9b shows a front view of the pivoting stand SST according to the invention, in Z-position Zb of the motorized lower Z-guide ZMU relative to the rotation axis DA, the pivot arm SA being situated in the vertical setting and the Z-position of the motorized upper Z-guide ZMO having a value Z2 relative to the rotation axis DA;

FIG. 9c shows a front view of the pivoting stand SST according to the invention, in Z-position Zc of the motorized lower Z-guide ZMU relative to the rotation axis DA, the pivot arm SA being situated in the vertical setting and the Z-position of the motorized upper Z-guide ZMO having a value Z2 relative to the rotation axis DA;

FIG. 9d shows a front view of the pivoting stand SST according to the invention, in Z-position Zd of the motorized lower Z-guide ZMU relative to the rotation axis DA, the pivot arm SA being situated in the vertical setting and the Z-position of the motorized upper Z-guide ZMO having a value Z2 relative to the rotation axis DA;

FIG. 10a shows the curve of the tractive force of the first tension spring ZFA throughout the spring travel according to the inventive arrangement in FIGS. 5a and 5b;

FIG. 10b shows the curve of the tractive force of the second tension spring ZFB throughout the spring travel according to the inventive arrangement in FIGS. 5a and 5b; and

FIG. 11 shows the active torque curves MZ1, MZ2, MZ3 according to the inventive arrangement shown in FIGS. 5a and 5b for the corresponding positions Z1, Z2, Z3 of the motorized upper guide ZMO across the pivot angle W, which are caused by the weight force Fg applied in each case in the instantaneously effective center of gravity S of the simultaneously pivoting structure and acting vertically downward, as well as the torque curve MZF across the pivot angle w, which results from the tractive force according to FIGS. 10a and 10b in the inventive arrangement of the tension springs according to FIGS. 5a and 5b.

According to the present invention, the movement of the pivot arm may be blocked by a high torque magnetic brake mounted about a rotation axis, which consists of a simultaneously pivoting part and a fixed part. In addition, the blocking may be suspended for the duration of a touch of a button by releasing the high torque magnetic brake, the button being arranged on the pivot arm SA in such a way that it can be conveniently pressed with at least one finger of the same hand which grasps an ergonomically shaped section of a pivot arm which is provided for grasping the pivot arm for setting the pivot angle.

The simultaneously pivoted part of the magnetic brake sits advantageously on an axle bolt, is securely screwed there to the axle bolt by means of a rear adapter ring and a rear roller bearing, and fixed in this position with a threaded pin to an axle bolt, a front roller bearing also being arranged on the axle bolt which is mounted, as is a rear roller bearing, in a bearing block, in which the fixed part of the magnetic brake may be screwed to the bearing block and forms an abutment for the rear roller bearing, the abutment being used to tension via an adapter ring the rear roller bearing against the front roller bearing supported in the bearing block, wherein a working gap suitable for operating the magnetic brake is present between the fixed part of the magnetic brake and the simultaneously pivoted part of the magnetic brake.

In this assembly, the axle bolt is securely connected to the joint part by means of a front ring tension spring assembly, which may be tensioned against the joint part by means of multiple countersunk screws and a front pressure disk, as well as by means of a rear ring tension spring assembly, which may be tensioned against the joint part by means of multiple countersunk screws and a rear pressure disk, in such a way that a pivotal movement about the rotation axis resulting from the above described mounting is possible only when the high torque magnetic brake is supplied with current.

In this case a force-free adjustment via the pivot arm is presupposed. The pivotal movement may be limited by a stop screw securely connected to the joint part and by a stop groove situated in the bearing block.

Advantageously, the ergonomically shaped section and the button are situated at the upper end of the pivot arm a sufficiently large distance removed from the rotation axis, such that the pivot arm may be moved with a reasonable expenditure of force for setting the pivot angle.

In an advantageous embodiment the arrangement of the button and the ergonomically shaped section is configured in such a way that a left-handed and a right-handed operation are equally possible.

The ergonomically curved top side of the pivot arm is expediently shaped in such a way that it may be comfortably grasped both with rightward-pointing left hand as well as with the leftward-pointing right hand, the button in this arrangement being in comfortable reach of the left thumb or the right thumb of the respective hand being used.

In another embodiment variant according to the invention, the joint part includes relative to the rotation axis an active lever arm, at which the tractive forces created as a result of a first tension spring and a second tension spring, each attached with their other end to the stand, may be coupled into the joint part via the arrangement of tensions springs on the stand in such a way that the torque to be applied by the user for setting the pivot angle, which is determined by the instantaneous Z-position of the motorized upper Z-guide and the weight of the simultaneously pivoted parts as a function of the instantaneous pivot angle and the position of the center of gravity, and by the frictional torque created by the mounting, may be significantly reduced by the tension springs in the entire pivot angle range independently of the instantaneous Z-position of the upper motorized Z-guide, to thereby facilitate operation by the user, wherein the torques present in the range of the vertical setting of the pivot arm created by the first tension spring and the second tension spring, and which support the movement in the direction of the vertical setting, contribute to a more rapid and simpler locating of the vertical setting of the pivot arm.

In this case, it is advantageous if the tractive forces created by the first tension spring and the second tension spring may be coupled into the joint part via the arrangement of tension springs on the stand in such a way that the torque to be applied by the user for setting the pivot angle, which is determined by the position of the center of gravity as a function of the instantaneous pivot angle and the instantaneous Z-position of the motorized upper Z-guide and by the weight force of the simultaneously pivoted parts acting there, and by the frictional torques created by the mounting, may be fully compensated over overcompensated by the tension springs over the entire pivot angle range between a bottom-most Z-position of the upper motorized Z-guide and at least up to a marginal-Z-position, in which a danger exists of tilting over the edge when falling short of the negative marginal pivot angle or over the edge when the marginal pivot angle is exceeded, wherein, the overcompensation results in stronger return torques, which makes it easier for the user to return the pivot arm to the vertical position.

It is also advantageous if the rotation axis of the pivot arm is determined from at least two low-friction roller bearings, and a sufficiently smooth locking assembly having a discernible lock-capturing range between the joint part and the fixed bearing block, wherein the active return forces, which result with minimal frictional losses from the locking assembly with the spring-loading forces and/or from the previously described arrangement for the mounting and locking assembly, lead to a rapid and reliable locating of a discernible and reproducible locking position for the vertical alignment of the pivot arm.

The fixed locking lever is mounted for pivotal movement about a rotation axis in the joint part and supports a locking ball bearing which has a rotation axis. The locking segment includes a sufficiently wear-resistant outer surface on which the locking ball bearing rolls and a lock geometry in which the locking ball bearing may engage. To produce the locking forces required for engagement, the locking lever is pressed by at least one tension spring or compression spring, for example, by the three compression springs, against the outer surface, for example, in the lock geometry of the locking segment, the lock geometry being designed such that the locking ball bearing is drawn into a stable locking position corresponding to a vertical alignment of the pivot arm at the start of the capture range, which noticeably begins already before reaching the vertical alignment of the pivot arm. The stable locking position also provides good reproducibility of the vertical alignment of the pivot arm.

The ergonomically shaped section of the pivot arm is advantageously provided with a surface which is clearly intended to be grasped, for example, a handle surface in the form of a soft-touch surface of contrasting color at the upper end of the pivot arm.

In a further advantageous embodiment, the instantaneous Z-coordinate of the motorized upper Z-guide is retrieved when the button is pressed, and the pivotal movement is permitted only when it is certain that the allowable marginal Z-position of the motorized upper Z-guide is not exceeded.

It is also advantageous if the instantaneous Z-coordinate of the motorized upper Z-guide is retrievable when the button is pressed, the angular position of the pivot arm may be determined by a measuring system and the pivotal movement is limited to a permissible pivot angle range as a function of the instantaneous Z-coordinate of the motorized upper Z-guide, wherein a blocking of the magnetic brake is not permitted outside the permissible pivot angle range and, when combined with the previously described tension spring assembly, a sufficiently strong return force is available for the return to the permissible pivot angle range, such that a release of the button outside the permissible pivot angle range results in a pivot angle that is set within the pivot angle range.

In this arrangement, the departure from the permissible pivot angle range should be indicated by an acoustic signal and/or a warning on the control and display unit.

It is further advantageous if the outer surface outside the lock geometry is curved in such a way that the locking ball bearing is consistently the same distance away from the rotation axis, as a result of which the contact force of the locking ball bearings against the outer surface of the locking segment consistently remains constant regardless of the pivot angle.

Moreover, the distance between the locking ball bearing and the rotation axis may be variable depending on the pivot angle, as a result of which the contact force of the locking ball bearing against the outer surface of the locking segment is also dependent on the pivot angle, the curvature being selectable such that the torque curves from the tension spring assembly described may be corrected to produce on the whole the desired torque curve as a function of the pivot angle.

It is equally advantageous that the upper end of the pivot arm is rotationally symmetrically designed about the vertical center axis in the vertical setting, thereby creating an ergonomically shaped section which may be comfortably grasped both with the rightward-pointing left hand and with the leftward-pointing right hand, the button situated on the upper end face of the pivot arm in this arrangement being in comfortable reach of the left thumb or right thumb of the respective hand being used.

The solution according to the invention enables the quick releasing and locking of the pivot arm with a short press of a button, the button being positioned at a suitable location, which can be reached with the same hand while setting the pivot arm.

In the current state of the art it has heretofore been necessary to use two hands to set the pivot arm, in which releasing and securing the clamping were relatively time-consuming.

In addition, the arrangement is cost-efficiently and effectively unencumbered as a result of the tension springs when compared to the state of the art, which in practice results in a more rapid and more precise setting of the pivot arm with higher image quality and, due to an easily achievable return torque, also to a simpler return of the pivot arm to the vertical position.

The fully integrated locking assembly for the vertical positioning of the pivot arm provides an exact locking position, it is easy to recognize and offers good reproducibility. Nearly identical locking forces are generated in both locking directions, no additional handles being required. To achieve a locking that is readily reproducible, a corresponding accuracy of the locking assembly and of all mountings is a prerequisite.

Particularly advantageous is the unencumbered, simple tension spring assembly composed of the first tension spring and the second tension spring, which enables more precise settings and which facilitates the return of the pivot arm to the vertical position as a result of the easily achievable return torque.

An encoding of the pivot angle is also useful, since it allows multiple actions to be carried out as a function of the pivot angle. This is not absolutely necessary, however.

The curvature of the outer surface outside the lock geometry may also be varied in such a way that the distance between the locking ball bearing and the rotation axis changes as a function of the pivot angle, as a result of which the contact force of the locking ball bearing against the outer surface of the locking segment is also a function of the pivot angle, in which the curvature may be selected such that the torque curves from the tension spring assembly are corrected to produce on the whole the desired torque curve as a function of the pivot angle.

A motorization of the upper and lower Z-guide is useful, since it allows various actions as a function of the Z-position to be carried out.

The geometry of the locking assembly or the lock geometry may be varied as long as the desired operative effect of the locking assembly or the lock geometry is not appreciably altered thereby. The most important criteria are a sufficiently large locking—capture range having maximally strong return forces or return torques by the locking assembly. The setting of the locking forces and the locking torques via set screws and/or multiple compression and/or tension springs may be varied arbitrarily. Setting using set screws is not absolutely necessary, however.

In addition, the tension spring assembly may also be varied such that the torque curves are altered accordingly, but in principal, still correspond to the advantageous dimensioning criteria.

Motorization, encoding or manual operation of both Z-guides is also conceivable.

High torque magnetic brakes are characterized by high holding torque in the zero-current state. If there are magnetic brakes having similarly high holding torques without being designated as such, these too, would be suitable for the use according to the invention.

The motorized lower Z-guide may be attached either to the stand based or to the bearing block or to both components.

The pivot arm stand according to the invention is explained in greater detail below with reference to exemplary embodiments. For this purpose:

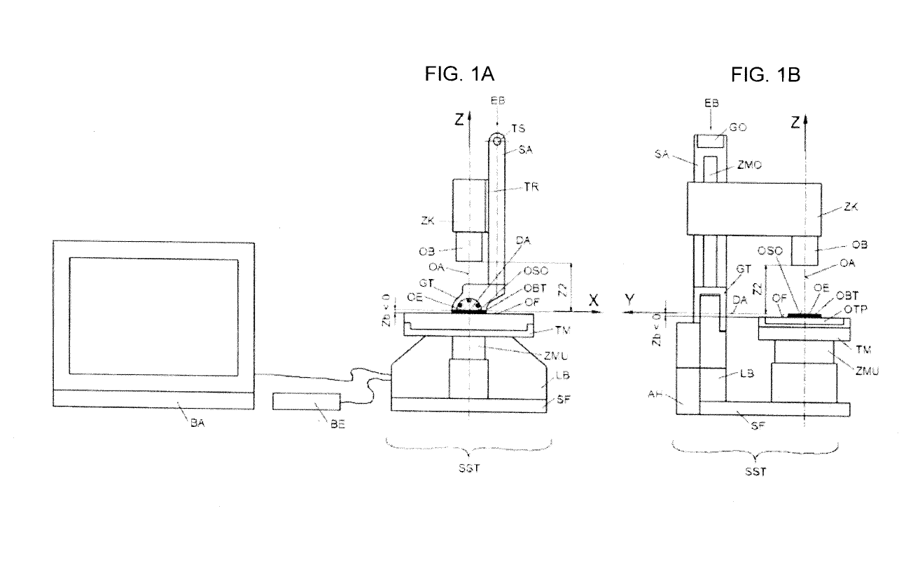

FIG. 1: shows representations of the digital microscope system with the pivoting stand,

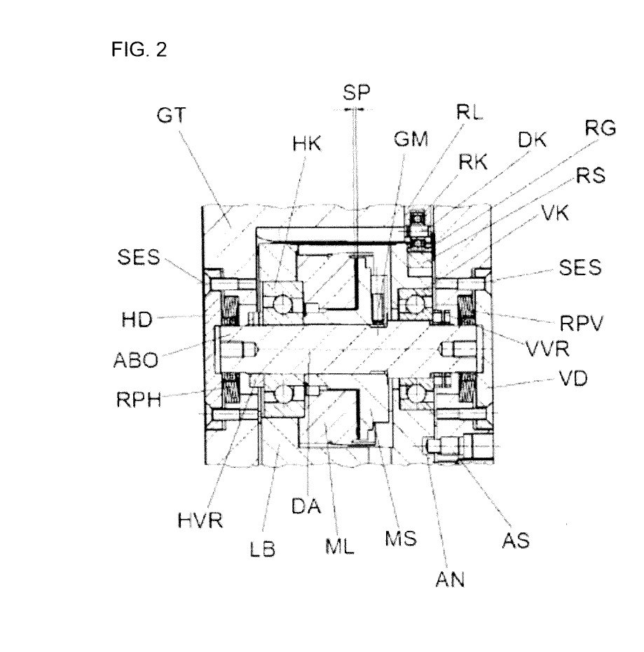

FIG. 2: shows an exemplary embodiment for the design of the mounting according to the invention, including magnetic brake and locking assembly,

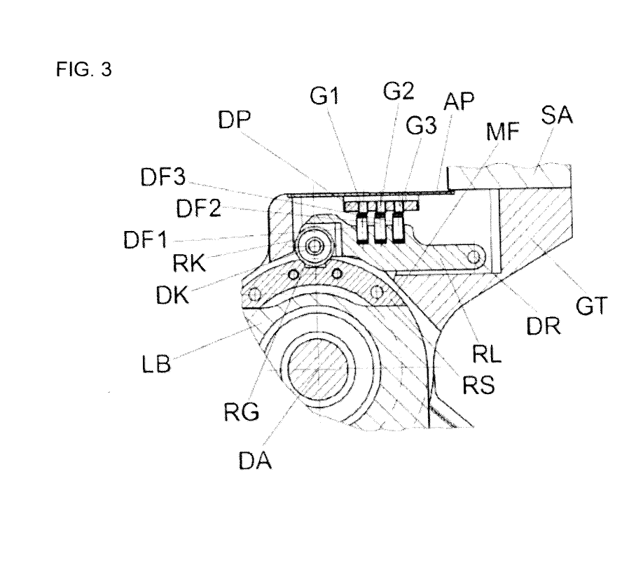

FIG. 3: shows an exemplary embodiment for the design of the locking assembly according to the invention,

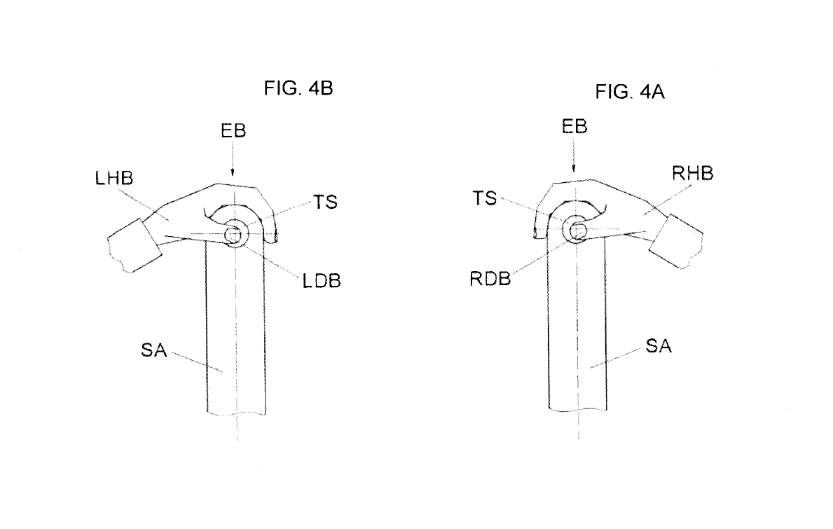

FIG. 4: shows representations of the front view of the one-hand operation of the pivoting function,

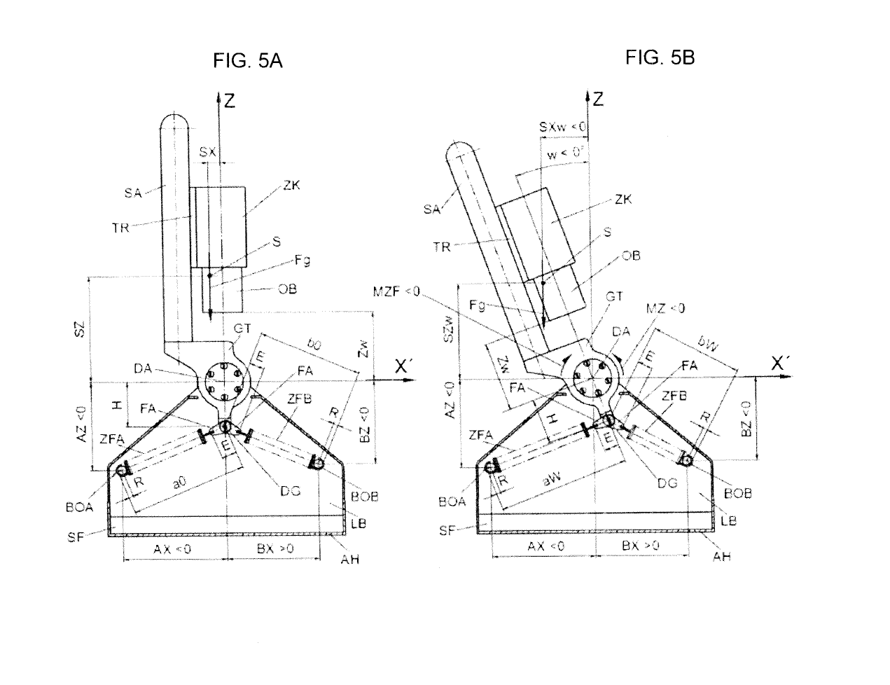

FIG. 5: shows representations of the rear view of the pivoting stand for illustrating the tension spring assemblies,

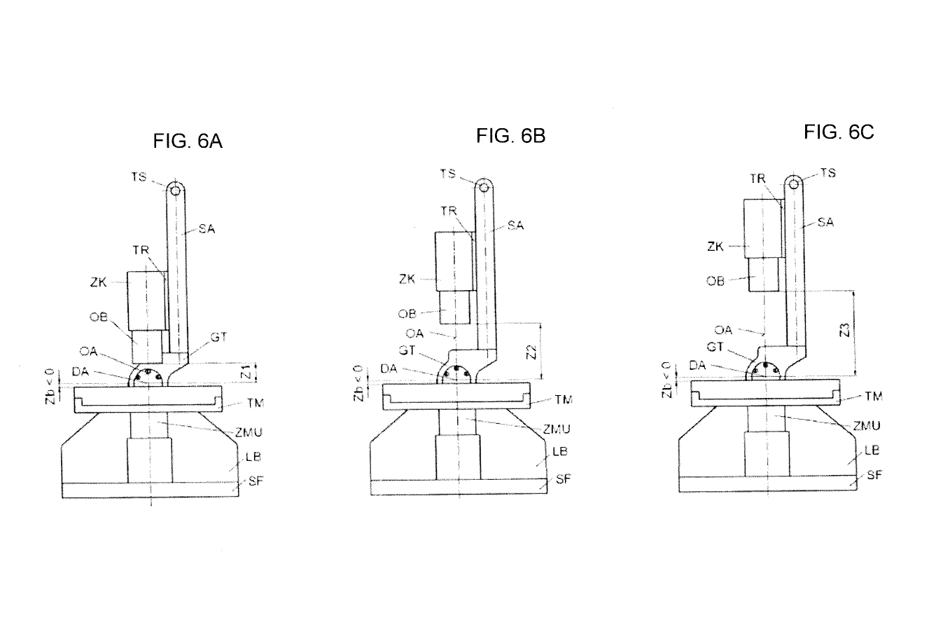

FIG. 6: shows representations of the front view of the pivoting stand in the vertical position in various Z-positions of the upper guide,

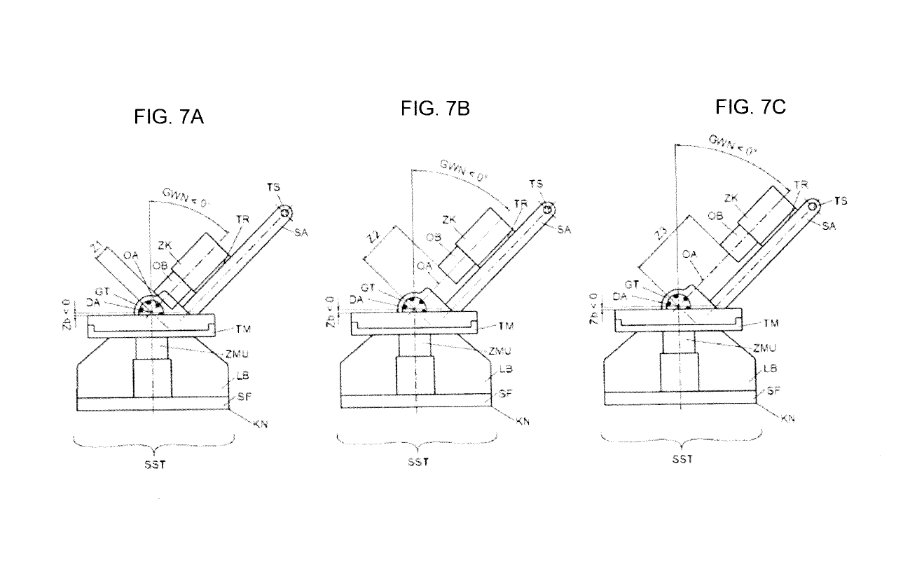

FIG. 7: shows representations of the front view of the pivoting stand pivoted in various Z-positions of the upper Z-guide,

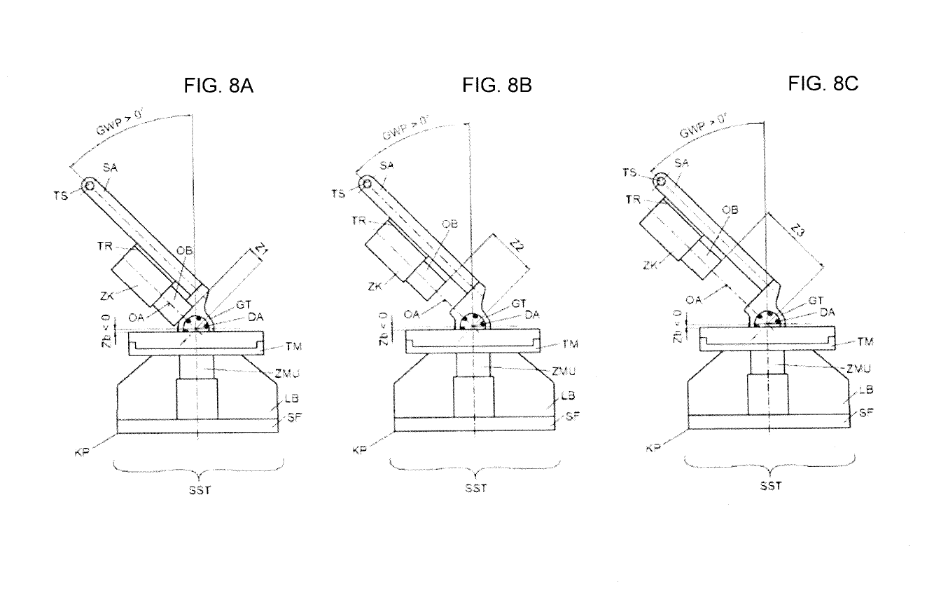

FIG. 8: shows further representations of the front view of the pivoting stand pivoted in various Z-positions of the upper Z-guide,

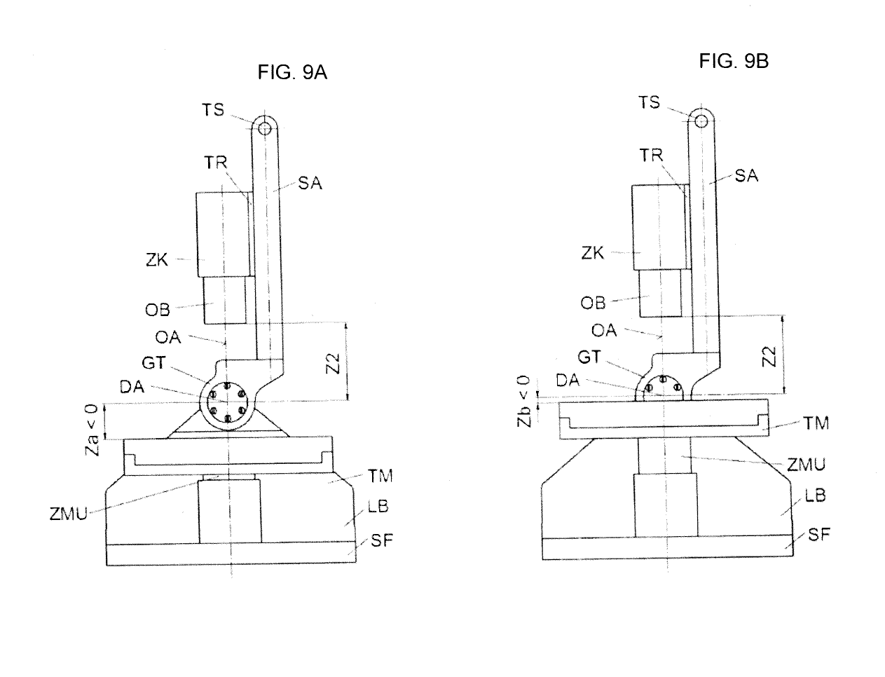

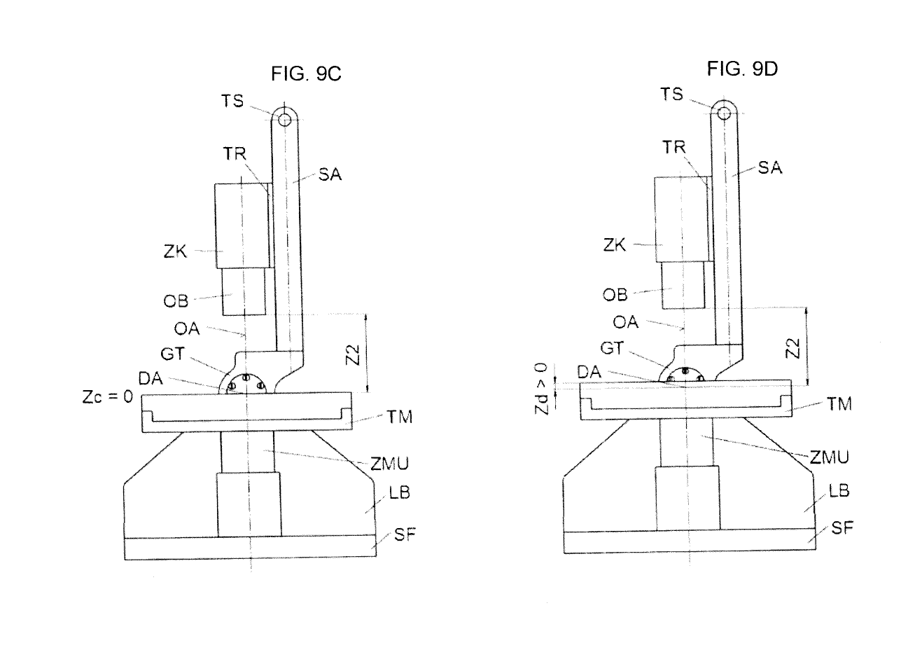

FIG. 9: shows further representations of the front view of the pivoting stand pivoted in various Z-positions of the lower Z-guide,

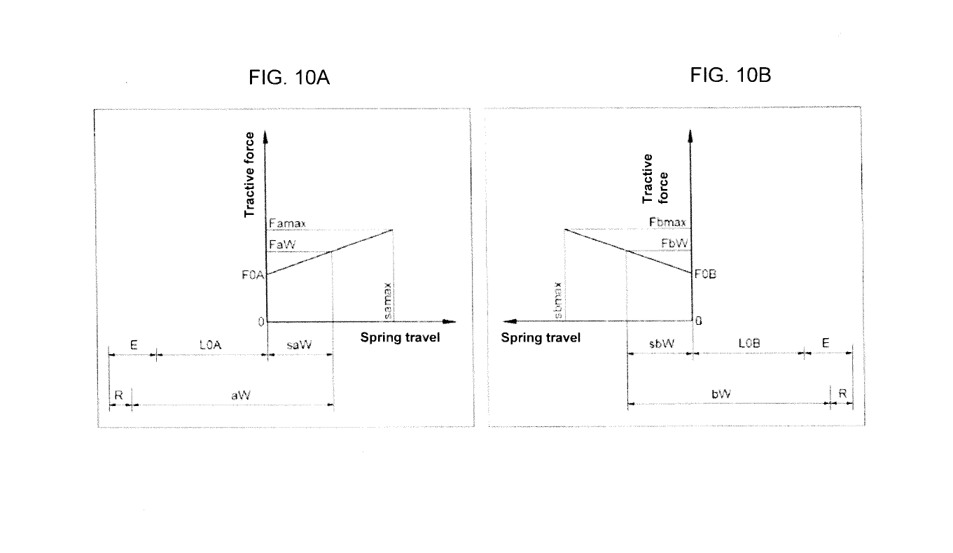

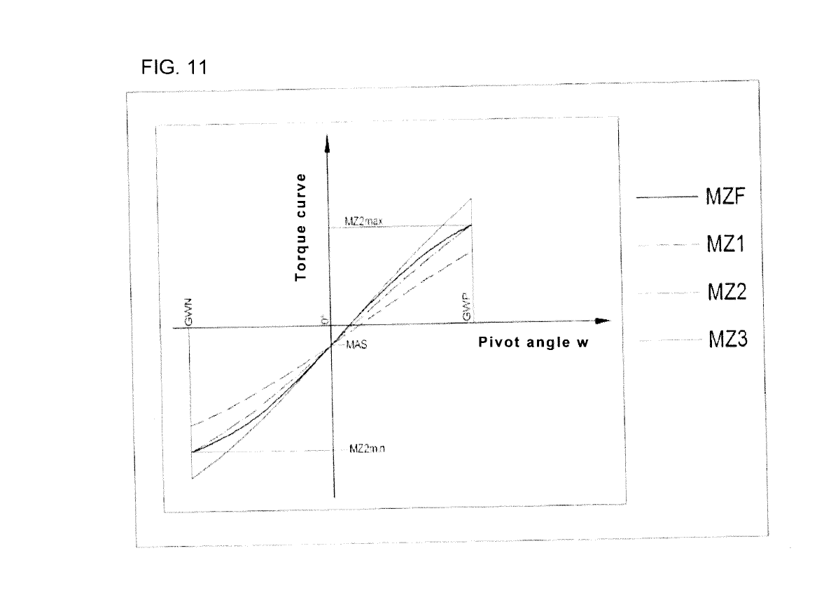

FIG. 10: shows representations of the curves of tension forces of a first and a second tension spring, and

FIG. 11: shows a representation of torque curves.

FIGS. 1a and 1b show a digital microscope system having a pivoting stand SST according to the invention. FIG. 1a includes a representation of the front view of the digital microscope system as seen from the user's perspective, including the pivoting stand SST according to the invention, a control unit BE, and a control and display unit BA, while FIG. 1b shows only the side view from the left of the pivoting stand SST according to the invention.

For purposes of orientation, a spatial coordinate system is introduced, consisting of a positive rightward-pointing X-axis as seen from the user's perspective, a positive rearward-pointing Y-axis as seen from the user's perspective, and a positive upward-pointing Z-axis as seen from the user's perspective. The coordinate system originates at the point of intersection of the rotation axis DA and the optical axis OA.

The pivoting stand SST includes a base SF on which a bearing block LB is mounted, in which a mounting for a joint part GT pivotable about a rotation axis DA and a pivot arm SA securely attached thereto is integrated. Situated on the pivot arm is a motorized upper Z-guide ZMO, by way of which a carrier TR for adapting the zoom body ZK in the Z-position relative to the rotation axis DA of the pivot arm SA may be varied. Shown in FIGS. 1a and 1b by way of example is a Z-position Z2 for the parts movable via the motorized upper Z-guide ZMO, to which, in addition to the carrier TR and the zoom body ZK, the lighting and camera integrated in the zoom body ZK, as well as the objective OB also belong. Attached to the base SF of the stand is a motorized lower Z-guide ZMU, whereby the motorized lower Z-guide ZMU could also alternatively be attached to the bearing block LB. The rear side of the pivoting stand SST is covered by a hood AH.

Adaptable to the variable, motorized lower Z-guide with respect to the Z-position relative to the rotation axis DA of the pivot arm SA is a preferably motorized XY-table TM, which includes a table top OTP, in which an incident light insertion plate functioning as an object support is integrated. According to FIGS. 1a and 1b, a Z-position Zb<0 is set on the motorized lower Z-guide ZMU, in which the upper side OSO of an objective OBT placed on the surface OF of the incident light insertion plate AE is situated in the rotation axis DA of the pivot arm. FIGS. 1a and 1b show the pivoting stand SST in the focused state, i.e. the upper side OSO of the objective OBT placed on the incident light insertion plate AE is situated in the object plane OE.

The pivot arm SA includes at its upper end an ergonomically shaped section EB having a handle surface GO, which is provided for grasping the pivot arm SA during the pivoting process. With a soft-touch surface of contrasting color, the ergonomically shaped section EB to be grasped is clearly identifiable while comfortable to the touch. The ergonomically shaped section EB and the button TS at the upper end of the pivot arm SA are arranged a sufficient distance removed from the rotation axis DA such that the pivot arm SA may be moved with a reasonable expenditure of force for setting the pivot angle.

FIG. 2 shows an exemplary embodiment for the design of the mounting according to the invention, including the magnetic brake and locking assembly.

The pivotal movement is blocked by a high torque magnetic brake, mounted about the rotation axis DA, for example, a “High Torque Permanent Magnetic Brake 400 mm cable rt/bl 86 61106P10-0 24V/Kendrion Binder Magnete Design, RoHS-compliant”, which according to FIG. 2 consists of a simultaneously pivoted part MS and a fixed part ML. The blocking may be suspended for the duration of the press of a button TS according to FIG. 1 by releasing the high torque magnetic brake, the button TS being situated on the pivot arm SA in such a way that it can be comfortably pressed with at least one finger of the same hand which grasps the ergonomically shaped section EB of the pivot arm SA which is provided for grasping the pivot arm SA for setting the pivot angle.

According to FIG. 2, the simultaneously pivoted part MS of the magnetic brake sits on an axle bolt ABO, is securely screwed there to the axle bolt ABO by means of a rear adapter ring HVR and a rear roller bearing HK, and fixed in this position with a threaded pin GM on the axle bolt. A front roller bearing VK is also arranged on the axle bolt ABO which is mounted, as is the rear roller bearing HK, in a bearing block LB, in which the fixed part ML of the magnetic brake is screwed to the bearing block and forms an abutment for the rear roller bearing HK, the abutment being used to tension the rear roller bearing HK against the front roller bearing VK supported in the bearing block LB with the aid of a front adapter ring VVR. The roller bearings used are preferably in the form of angular contact ball bearings, which are higher load bearing than normal deep groove ball bearings and may therefore, if needed, be more rigidly tensioned against one another. Present between the fixed part ML of the magnetic brake and the simultaneously pivoted part MS of the magnetic brake is, as a result of the selected arrangement, a working gap SP suitable for operating the magnetic brake. A front pressure disk VD is pressed by means of multiple countersunk screws SES against a front ring tension spring assembly RPV, which as a result connects the front section of the joint part GT to the axle bolt ABO. Similarly, a rear pressure disk HD is pressed by means of multiple countersunk screws SES against a rear ring tension spring assembly RPH which as a result connects the rear section of the joint part GT to the axle bolt ABO. In this way, the joint part GT is so securely connected to the axle bolt ABO that a pivotal movement about the rotation axis DA resulting from the described mounting is practically possible only when the high torque magnetic brake is supplied with current, whereby a force-free adjustment pivot arm SA is presupposed. The pivotal movement may be limited by a stop screw AS, which is securely connected to the joint part GT and which engages in a stop groove AN situated in the bearing block LB.

FIG. 2 also shows parts of the locking assembly according to the invention, which are described in greater detail in FIG. 3. A locking roller bearing RK having a rotation axis DK and arranged in a fixed locking lever RL engages in a lock geometry RG in the locking segment RS, the locking segment RS being securely mounted on the bearing block LB.

FIG. 3 shows an exemplary embodiment for the design of the locking assembly according to the invention.

The fixed locking lever RL is mounted for pivotal movement about a rotation axis DR in the joint part GT and supports a locking ball bearing RK which has a rotation axis DK. The locking segment RS includes a sufficiently wear-resistant outer surface MF on which the locking ball bearing RK rolls and a lock geometry RG in which the locking ball bearing RK may engage. To produce the locking forces required for engagement, the locking lever RL is pressed by at least one tension spring or compression spring, for example, by the three compression springs DF1, DF2 and DF3, against the outer surface MF in the lock geometry of the locking segment RS, the lock geometry RG being designed such that the locking ball bearing RK is drawn into a stable locking position corresponding to a vertical alignment of the pivot arm SA from the start of the capture range, which noticeably begins already before reaching the vertical alignment of the pivot arm SA. The stable locking position also provides good reproducibility of the vertical alignment of the pivot arm SA.

in the exemplary embodiment according to FIG. 3, the compression springs DF1, DF2 and DF3 are braced against the threaded pins G1, G2, G3, which are arranged in a pressure plate DP connected to the joint part GT. When needed, the threaded pins G1, G2, G3 may be used to vary the contact forces. The locking assembly in the joint part GT is covered by a cover plate AP, in such a way that it is not visible from the outside.

FIGS. 4a and 5b show in front view an exemplary embodiment for the one-handed operation according to the invention of the pivot function of the pivot arm SA using the button TS and an ergonomically shaped section EB which is equally suited to right-handed and left-handed persons. FIG. 4b shows the operation by the user using the left hand LHB, while FIG. 4a shows the operation by the user using the right hand RHB. The ergonomically curved upper side of the pivot arm SA is shaped in such a way that the resulting ergonomically shaped section EB may be comfortably grasped both with the rightward-pointing left hand LHB, as well as with the leftward-pointing right hand RHB, whereby from the outset the button is in comfortable reach of the thumbs LDB and RDB of the respective hand being used.

To illustrate the function according to the invention of the first tension spring ZFA and the second tension spring ZFB, FIG. 5a shows the rear view of the pivoting stand SST according to the invention with the pivot arm SA in the vertical setting, and FIG. 5b shows the rear view of the pivoting stand according to the invention with a pivot arm SA tilted about the instantaneous pivot angle w relative to the vertical alignment, in each case the center of gravity S of the simultaneously pivotable structure being shown, which also includes the joint part GT, the pivot arm SA, the carrier TR, the zoom body ZK with integrated lighting and camera, as well as the objective OB.

The joint part GT includes relative to the rotation axis DA an active lever arm H, at which the tractive forces created as a result of a first tension spring ZFA and a second tension spring ZFB, each attached with their other end to the stand, may be coupled into the joint part GT via the arrangement of tensions springs on the stand. The torque to be applied by the user for setting the pivot angle w, which is determined by the position of the center of gravity S as a function of the instantaneous pivot angle as well as the instantaneous Z-position of the motorized upper Z-guide ZMO, and of the applied weight of the simultaneously pivoted parts, and by the frictional torque created by the mounting, may be significantly reduced by the tension springs in the entire pivot angle range independently of the instantaneous Z-position of the upper motorized Z-guide ZMO, to thereby facilitate operation by the user. In this arrangement, the torques present in the range of the vertical setting of the pivot arm SA created by the first tension spring ZFA and the second tension spring ZFB, and which support the movement in the direction of the vertical setting, contribute to a more rapid and simpler locating of the vertical setting of the pivot arm SA.

The designations otherwise correspond to the designations from FIGS. 1a and 1b.

To illustrate the setting options, FIGS. 6a, 6b and 6c show a front view of the pivoting stand SST according to the invention, in each case in various Z-positions Z1, Z2, Z3 of the motorized upper Z-guide ZMO relative to the rotation axis DA, the pivot arm SA being situated in the vertical setting and the Z-position of the motorized lower Z-guide ZMU having a value Zb<0 relative to the rotation axis DA. The designations otherwise correspond to the designations from FIGS. 1a and 1b.

To illustrate the setting options, FIGS. 7a, 7b and 7c show a front view of the pivoting stand SST according to the invention, in each case in various Z-positions Z1, Z2, Z3 of the motorized upper Z-guide ZMO relative to the rotation axis DA, the pivot arm being tilted to the right by the negative marginal pivot angle GWN<0° relative to the vertical alignment, and the Z-position of the motorized lower Z-guide ZMU having a value Zb<0 relative to the rotation axis DA. The negative marginal pivot angle GWN<0° is characterized in that a danger of tilting about the edge KN exists when this angle is exceeded by an amount, to the extent a marginal Z-position Z2 of the motorized upper Z-guide ZMO relative to the rotation axis DA is exceeded. According to FIG. 7b the pivoting stand SST shown therein verges on the risk of tilting. According to FIG. 7a, the pivoting stand SST shown therein is situated within the secure operating range. According to FIG. 7c the pivoting stand SST shown therein is situated in an unsafe condition which must be avoided at all cost. This can be achieved, for example, by designing the pivot angle range and the maximum achievable Z-position of the motorized upper Z-guide ZMO relative to the rotation axis DA so narrowly that a danger of tilting may be eliminated in all possible combinations of pivot angle and Z-position of the upper Z-guide ZMO; this means in practice a disadvantageous restriction of the range of use.

This disadvantage may be avoided with the arrangement according to the invention if, when pressing the button TS, the instantaneous Z-coordinate of the motorized upper Z-guide ZMO is retrieved with the aid of a corresponding control electronics having software contained, for example, in the control and display unit BA according to FIG. 1a, and the pivoting movement is permitted only when the allowable marginal Z-position Z2 of the motorized upper Z-guide ZMO falls below the limit. A further possibility based on the arrangement according to the invention is that the instantaneous Z-coordinate of the motorized upper Z-guide ZMO is retrieved with the push of a button with the aid of a corresponding control electronics having software contained, for example, in the control and display unit BA according to FIG. 1a, the angular position of the pivot arm SA may be determined by an angle measuring system and the pivotal movement is limited to a permissible pivot angle range as a function of the instantaneous Z-coordinate of the motorized upper Z-guide ZMO, wherein a blocking of the magnetic brake is not permitted outside the permissible pivot angle range and, when combined with the tension spring assembly according to FIGS. 5a and 5b, a sufficiently strong return force is available for the return to the permissible pivot angle range, such that a release of the button TS outside the permissible pivot angle range results in a pivot angle that is set within the pivot angle range.

In this arrangement, it is advantageous if the departure from the permissible pivot angle range is indicated by an acoustic signal and/or a warning on the control and display unit. The designations otherwise correspond to the designations from FIGS. 1a and 1b.

To illustrate the setting options, FIGS. 8a, 8b and 8c show a front view of the pivoting stand SST according to the invention, in each case in various Z-positions Z1, Z2, Z3 of the motorized upper Z-guide ZMO relative to the rotation axis DA, the pivot arm SA being tilted to the left relative to the vertical alignment by the positive marginal pivot angle GWP and the Z-position of the motorized lower Z-guide ZMU having a value Zb<0 relative to the rotation axis DA. The foregoing explanations with respect to FIGS. 7a, 7b and 7c apply analogously to FIGS. 8a, 8b and 8c. Only the pivot direction changes; the positive marginal pivot angle GWB signifies in practice a pivotal movement to the left with a danger of tipping over the edge KP. The designations otherwise correspond to the designations from FIGS. 1a and 1b.

The tension spring assembly according to the arrangement in FIGS. 5a and 5b may, in principle, be dimensioned so that the torque required for the pivotal movement without the tension spring assembly may be fully compensated over overcompensated by the tension springs over the entire pivot angle range between a bottom-most Z-position Z1 of the upper motorized Z-guide ZMO and at least up to a marginal-Z-position Z2, in which a danger of tilting over the edge KN exists when falling short of the negative marginal pivot angle GWN or over the edge KP when the marginal pivot angle GWP is exceeded, the overcompensation resulting in stronger return torques, which makes it easier for the user to return the pivot arm SA to the vertical position.

To illustrate the setting possibilities, FIGS. 9a, 9b, 9c and 9d show a front view of the pivoting stand SST according to the invention, in each case in varying Z-positions Za, Zb, Zc, Zd of the motorized lower Z-guide ZMU relative to the rotation axis DA, the pivot arm SA being situated in the vertical setting and the Z-position of the motorized upper Z-guide ZMO having a value Z2 relative to the rotation axis DA. The designations otherwise correspond to the designations from FIGS. 1a and 1b.

FIG. 10a shows the curve of the tractive force of the first tension spring ZFA throughout the spring travel according to the inventive arrangement in FIGS. 5a and 5b. Analogously, FIG. 10b shows the curve of the tractive force of the second tension spring ZFB throughout the spring travel according to the inventive arrangement in FIGS. 5a and 5b.

Starting from the spring length LOA in the non-tensioned state, a length aW formed from the effective length of the first tension spring ZFA plus the spring support FA rotatably mounted about the rotation axis DG is produced in the mounted, tensioned state when the pivot arm SA is deflected to the instantaneous effective pivot angle w relative to the vertical setting of the pivot arm SA. The designations otherwise correspond to the designations from FIGS. 5a and 5b.

FIG. 11 shows the active torque curves MZ1, MZ2, MZ3 according to the inventive arrangement shown in FIGS. 5a and 5b for the corresponding positions Z1, Z2, Z3 of the motorized upper guide ZMO across the pivot angle W, which are caused by the weight force Fg applied in each case in the instantaneously effective center of gravity S of the simultaneously pivoting structure and acting vertically downward, as well as the torque curve MZF across the pivot angle w, which results from the tractive force according to FIGS. 10a and 10b in the inventive arrangement of the tension springs according to FIGS. 5a and 5b.

Since the center of gravity of the pivot arm SA with the attached simultaneously pivoting parts in the vertical position of the pivot arm SA according to FIG. 5a is centered laterally adjacent the rotation axis, even in the vertical position of the pivot arm SA a torque MAS takes effect which is identical for the torque curves MZ1, MZ2 and MZ3. The tension spring assembly according to FIGS. 5a and 5b is dimensioned in such a way that even the torque curve MZF in the vertical position of the pivot arm SA assumes the value MAS, since a full torque compensation must exist in the vertical position, because otherwise a torque would exist which would pull the simultaneously pivoting parts in an undesirable manner again out of the desired locking position for the vertical setting of the pivot arm SA.

The torque curves are limited by design, for example, to the marginal pivot angles GWN and GWP, with the maximum torques MZ2min and MZWmax created as a result of the tension springs. The torque curve MZF is preferably shaped so that the torque curves MZ1 and MZ2 for the Z-positions Z1 and Z2 of the motorized upper Z-guide ZMO consistently provide lower torques relative to the rotation axis DA, such that as a result of the stronger torque curve for the tension springs a return torque is always present in the vertical setting of the pivot arm SA. If the Z-positions Z2 of the motorized upper Z-guide ZMO are exceeded, the magnetic brake may be blocked only up to the pivot angle at which a return force is present which is just sufficiently strong enough. A blocking is possible again, only when the permissible operating range is no longer exceeded. In this case, the return forces automatically result in a movement in the direction of the permissible pivot angle range. If the Z-position of the motorized upper Z-guide ZMO is moved so far toward the top that a permissible pivot angle range no longer exists, the locking position for the vertical setting of the pivot arm is not left, i.e. the blocking of the magnetic brakes cannot be suspended.

Since for safety reasons no danger may be posed by the assembly according to the invention even in the zero-current state, the element used is a magnetic brake which blocks a pivotal movement in the zero-current state by means of the integrated permanent magnets. Only when the button is pressed is the excitation winding of the magnetic brake energized and in this way neutralizes the magnetic field of the permanent magnets, which in practice results in a release of the blocking of the pivotal movement. To ensure a possible one-hand operation, the button must be operable during the holding and setting process using the same hand that grasps the pivot arm. The largest lever allows for setting of the pivot arm while requiring the least amount of force and with the best possible setting accuracy. For that reason, the upper end of the pivot arm is designed in such a way that it can be easily grasped with both the right and the left hand, for which purpose the upper end is conveniently rounded. Preferably, the upper side of the pivot arm is provided with a surface intended for grasping, recognizable for example by a soft-touch surface of contrasting color. Since the hand lies laterally over the pivot arm, the thumb of the same hand may now be used to easily press the button on the front side of the pivot arm.

Preferably, the rotation axis DA of the pivot arm SA is defined by two low-friction roller bearings VK and HK and a sufficiently smoothly operating locking assembly having a discernible locking capture range situated between the joint part GT and the fixed bearing block LB. The active return forces resulting from the locking assembly with the spring loading forces and/or the arrangement according to FIGS. 5a and 5b with low frictional losses for the mounting and locking assembly result in a rapid and reliable locating of a discernible and reproducible locking position for the vertical alignment of the pivot arm SA.

The locking capture range is defined by the pivot angle range, in which the return forces or return torques acting exclusively as a result of the locking assembly result in a movement into the locking position.

For the pivoting stand according to the invention, the following correlations apply, the individual symbols being explained in greater detail in the list of reference numerals:

$$aW = \sqrt{{( AX + H \cdot sin w )}^{2} + {( AZ + H \cdot cos w )}^{2}}$$

$$bW = \sqrt{{( BX + H \cdot sin w )}^{2} + {( BZ + H \cdot cos w )}^{2}}$$

$$saW = aW + R - E - L 0 A$$

$$sbW = bW + R - E - L 0 B$$

$$FaW = F 0 A + cA \cdot saW$$

$$FbW = F 0 B + cB \cdot sbW$$

$$MZF = H \cdot ( FbW \cdot cos ( {tan}^{- 1} ( \frac{- BZ - H \cdot cos w}{BX + H \cdot sin w} ) - w ) - FaW \cdot sin ( 90 ° - {tan}^{- 1} ( \frac{AZ + H \cdot cos w}{AX + H \cdot sin w} ) - w ) )$$

$$MZ 1 = Fg \cdot ( SZ 1 W \cdot sin w + SX 1 W \cdot cos w )$$

$$MZ 2 = Fg \cdot ( SZ 2 W \cdot sin w + SX 2 W \cdot cos w )$$

$$MZ 3 = Fg \cdot ( SZ 3 W \cdot sin w + SX 3 W \cdot cos w )$$

### LIST OF REFERENCE NUMERALS

a0 effective length of the first tension spring ZFA plus the spring support FA rotatably mounted about the rotation axis DG in the vertical setting of the pivot arm SA
ABO axle bolt
AH hood
AN stop groove
AP cover plate for the locking assembly
AS stop screw
aW effective length of the first tension spring ZFA plus the spring support FA rotatably mounted about the rotation axis DG when the pivot arm SA is deflected by the instantaneous effective pivot angle w relative to the vertical setting of the pivot arm SA
AX position of the bolt BOA relative to the rotation axis DA of the pivot arm SA in the X-direction
AZ position of the bolt BOA relative to the rotation axis DA of the pivot arm SA in the Z-direction
b0 effective length of the second tension spring ZFB plus the spring support FA rotatably mounted about the rotation axis DG in the vertical setting of the pivot arm SA
BA control and display unit
BE control unit
BOA bolt for fastening a spring end of the first tension spring ZFA to the bearing block LB
BOB bolt for fastening a spring end of the second tension spring ZFB to the bearing block LB
bW effective length of the second tension spring ZFB plus the spring support FA rotatably mounted about the rotation axis DG when the pivot arm SA is deflected by the instantaneous effective pivot angle w relative to the vertical setting of the pivot arm SA
BX position of the bolt BOB relative to the rotation axis DA of the pivot arm SA in the X-direction
BZ position of the bolt BOB relative to the rotation axis DA of the pivot arm SA in the Z-direction
cA spring rate of the first tension spring ZFA
cB spring rate of the second tension spring ZFB
DA rotation axis of the pivot arm
DF1 first compression spring
DF2 second compression spring
DF3 third compression spring
DG rotation axis for the mounting of the spring supports FA
DR rotation axis of locking lever
DK rotation axis of the locking ball bearing
DP pressure plate
E effective distance between the rotation axis DG and one spring end each of the first tension spring ZFA and the second tension spring ZFB
EB ergonomically shaped section of the pivot arm SA which is provided for grasping the pivot arm SA during the pivoting process
F0A spring bias of the first tension spring ZFA
F0B spring bias of the second tension spring ZFB
FA spring support which is rotatably mounted about a rotation axis DB in the joint part GT.
Famax maximum spring force of the first tension spring ZFA
FaW instantaneous spring force of the first tension spring ZFA
Fbmax maximum spring force of the second tension spring ZFB
FbW instantaneous spring force of the second tension spring ZFB
Fg vertically downward acting total weight force of all simultaneously pivoting components
G1 first threaded pin
G2 second threaded pin
G3 third threaded pin
GM threaded pin for fixing the magnetic brake to the axle bolt
GO handle surface at the upper end of the pivot arm
GT joint part
GWN negative marginal pivot angle
GWP positive marginal pivot angle limit
H active lever arm for the tension forces of the first tension spring ZFA and the second tension spring ZFB which are introduced via the two spring supports FA into the joint part GT
HD rear pressure disk
HK rear roller bearing
HVR rear adapter ring
KN edge over which the entire pivoting stand SST may tilt if the marginal Z-position Z2 of the motorized Z-guide is exceeded and, at the same time, the negative marginal pivot angle GWN is not exceeded
KP edge over which the entire pivoting stand SST may tilt if the marginal Z-position Z2 of the motorized Z-guide is exceeded and, at the same time, the positive marginal pivot angle GWP is not exceeded.
L0A non-tensioned length of the first tension spring ZFA
L0B non-tensioned length of the second tension spring ZFB
LB bearing block
LDB user's left thumb
LHB user's left hand
MAS torque created by the eccentric center of gravity S of the simultaneously pivoted components in the vertical arrangement
MF outer surface of the locking segment RS
ML part of magnetic braked affixed to the bearing block
MS simultaneously pivoted part of the magnetic brake
MZ torque curve across the pivot angle which is created by the weight force applied in the instantaneously effective center of gravity S of the simultaneously pivoting components, based on the instantaneously active Z-position of the upper Z-guide relative to the rotation axis DA of the pivot arm SA
MZ1 torque curve across the pivot angle which is created by the weight force applied in the instantaneously effective center of gravity S of the simultaneously pivoting components, when the bottom-most Z-position Z1 of the upper Z-guide is set relative to the rotation axis DA of the pivot arm SA
MZ2 torque curve across the pivot angle which is created by the weight force applied in the instantaneously effective center of gravity S of the simultaneously pivoting components, when the marginal Z-position Z2 of the upper Z-guide is set relative to the rotation axis DA of the pivot arm SA
MZ2max maximum torque of the torque curve MZ2
MZ2min minimum torque of the torque curve MZ2
MZ3 torque curve across the pivot angle which is created by the weight force applied in the instantaneously effective center of gravity S of the simultaneously pivoting components, when the uppermost Z-position Z3 of the upper Z-guide is adjusted relative to the rotation axis DA of the pivot arm SA
MZF torque curve across the pivot angle resulting from the introduction of the tractive forces from the first tension spring ZFA and the second tension spring ZFB via a lever H into the joint part GT
OA optical axis
OB objective
OBT object
OE object plane
OF surface of the incident light insertion plate which functions as an object support
OSO upper side of the object OBT
OTB upper table top
R effective radius at the bolts BOA and BOB for fastening one spring end each of the first tension spring ZFA and the second tension spring ZFB
RDB user's right thumb
RG lock geometry in the locking segment RS
RHB user's right hand
RK locking ball bearing
RL locking lever
RPH rear ring tension spring assembly
RPV front ring tension spring assembly
RS locking segment
S instantaneously effective center of gravity of the complete upper stand portion pivotable about the rotation axis, including the moved portion consisting of zoom body, objective, lighting and camera
samaxmaximum spring travel of the first tension spring ZFA
saW instantaneous spring travel of the first tension spring ZFA
SA pivot arm
sbmaxmaximum spring travel of the second tension spring ZFB
sbW instantaneous spring travel of the second tension spring ZFB
SES countersunk screw
SF stand base
SP working gap of the magnetic brake
SST entire pivoting stand
SX position of the instantaneously effective center of gravity S in the X-direction relative to the rotation axis DA in the vertical position of the pivot arm
SX1w position of the instantaneously effective center of gravity S in the X-direction relative to the rotation axis DA, when the pivot arm is pivoted about the pivot angle w, and when the bottom-most Z-position of the upper Z-guide is set relative to the rotation axis DA of the pivot arm.
SX2w position of the instantaneously effective center of gravity S in the X-direction relative to the rotation axis DA, when the pivot arm is pivoted about the pivot angle w, and when the marginal Z-position of the upper Z-guide is set relative to the rotation axis DA of the pivot arm.
SX3w position of the instantaneously effective center of gravity S in the X-direction relative to the rotation axis DA, when the pivot arm is pivoted about the pivot angle w, and when the uppermost Z-position of the upper Z-guide is set relative to the rotation axis DA of the pivot arm.
SXw position of the instantaneously effective center of gravity S in the X-direction relative to the rotation axis DA when the pivot arm is pivoted about the pivot axis w
SZ position of the instantaneously effective center of gravity S in the Z-direction relative to the rotation axis DA in the vertical setting of the pivot arm
SZ1w position of the instantaneously effective center of gravity S in the Z-direction relative to the rotation axis DA, when the pivot arm is pivoted about the pivot angle w, and when the bottom-most Z-position of the upper Z-guide is set relative to the rotation axis DA of the pivot arm
SZ2w position of the instantaneously effective center of gravity S in the Z-direction relative to the rotation axis DA, when the pivot arm is pivoted about the pivot angle w, and when the marginal Z-position of the upper Z-guide is set relative to the rotation axis DA of the pivot arm.
SZ3w position of the instantaneously effective center of gravity S in the Z-direction relative to the rotation axis DA, when the pivot arm is pivoted about the pivot angle w, and when the uppermost Z-position of the upper Z-guide is set relative to the rotation axis DA of the pivot arm.
SZw position of the instantaneously effective center of gravity S in the Z-direction relative to the rotation axis DA when the pivot arm is pivoted about the pivot axis w
TM XY table, preferably motorized
TR carrier for adapting the zoom body on the motorized upper Z-guide
TS button for releasing the pivot arm
VD front pressure disk
VK front roller bearing
VVR front adapter ring
w instantaneously effective pivot angle
x X-axis of the coordinate system used, from the user's perspective pointing to the right
x X-axis of the coordinate system, used only for dimensioning the tension spring as viewed from the rear according to FIGS. 7a and 7b; from the users perspective, pointing positively to the right; relative to the X-axis only the signs of the distances are reversed
Y Y-axis of the coordinate system used, from the user's perspective, pointing positively to the rear
Z Z-axis of the coordinate system used, from the user's perspective, pointing positively upward
Z1 lowest Z-position of the upper Z-guide relative to the rotation axis DA of the pivot arm
Z2 marginal Z-position of the upper Z-guide relative to the rotation axis DA of the pivot arm
Z3 uppermost Z-position of the upper Z-guide relative to the rotation axis DA of the pivot arm
Za bottom-most Z-position of the lower Z-guide relative to the rotation axis DA of the pivot arm
Zb Z-position of the lower Z-guide relative to the rotation axis DA of the pivot arm, in which the upper side OSO of an object OBT placed on the surface OF of the incident light insertion plate AE lies in the rotation axis DA of the pivot arm, provided that the object OBT has a height of zb
Zc Z-position of the lower Z-guide relative to the rotation axis DA of the pivot arm, in which the surface OF of the incident light insertion plate AE lies in the rotational axis DA of the pivot arm, i.e. Zc=0
Zd uppermost Z-position of the lower Z-guide relative to the rotation axis DA of the pivot arm
ZFA first tension spring
ZFB second tension spring
ZK zoom body with integrated lighting and integrated camera
ZMO motorized upper Z-guide
ZMU motorized lower Z-guide
zw instantaneous Z-position of the upper Z-guide relative to the rotation axis DA of the pivot arm

1. A pivot arm stand for digital microscopes having a pivot arm pivotable about a rotation axis,
wherein the movement of the pivot arm is blocked by a high torque magnetic brake arranged about a rotation axis (DA),
wherein the high torque magnetic brake comprises a simultaneously pivoting part (MS) and a fixed part (ML),
wherein the blocking is suspended for the duration of a touch of a button (TS) by releasing the high torque magnetic brake,
wherein the button (TS) is arranged on the pivot arm (SA) in such a way that it can be pressed with at least one finger of the same hand which clasps an ergonomically shaped section (EB) of the pivot arm (SA), and
wherein the ergonomically shaped section (EB) of the pivot arm (SA) is provided for grasping the pivot arm (SA) for setting a pivot angle (w).

2. The pivot arm stand for digital microscopes according to claim 1,
wherein the simultaneously pivoted part (MS) of the magnetic brake sits on an axle bolt (ABO), is securely screwed there to the axle bolt (ABO) by means of a rear adapter ring (HVR) and a rear roller bearing (HK), and is fixable in this position with a threaded pin (GM) to an axle bolt (ABO),
wherein a front roller bearing (VK) is further arranged on the axle bolt (ABO) which is mounted along with rear roller bearing (HK) in a bearing block (LB),
wherein the fixed part (ML) of the magnetic brake is screwed to the bearing block (LB) and forms an abutment for the rear roller bearing (HK), the abutment being used to tension the rear roller bearing (HK) against the front roller bearing (VK) supported in the bearing block (LB) via an front adapter ring (VVR),
wherein a working gap (SP) suitable for operating the magnetic brake is present between the fixed part (ML) of the magnetic brake and the simultaneously pivoted part (MS) of the magnetic brake, and the axle bolt (ABO) is securely connected by means of a front ring tension spring assembly (RPV) which may be tensioned via multiple countersunk screws (SES) and a front pressure disk (VD) against a joint part (GT), as well as by means of a rear ring tension spring assembly (RPH) which may be tensioned via multiple countersunk screws (SES) and a rear pressure disk (HD) against the joint part (GT), to the joint part (GT) in such a way that a pivotal movement about the rotation axis (DA) resulting from the mounting is possible only when the high torque magnetic brake is supplied with current, and
wherein a force-free adjustment via the pivot arm (SA) is presupposed and the pivotal movement is limited by a stop screw (AS), which is securely connected to the joint part (GT) and by a stop groove (AN) which is situated in the bearing block (LB).

3. The pivot arm stand for digital microscopes according to claim 1,
wherein the ergonomically shaped section (EP) and the button (TS) are situated at the upper end of the pivot arm (SA) at a sufficiently large distance removed from the rotation axis (DA), such that the pivot arm (SA) may be moved with a reasonable expenditure of force for setting the pivot angle (w).

4. The pivot arm stand for digital microscopes according to claim 1,
wherein the arrangement of the button (TS) and the ergonomically shaped section (EB) are configured so as to make a left and a right-handed operation equally possible.

5. The pivot arm stand for digital microscopes according to claim 1,
wherein the ergonomically curved upper side of the pivot arm (SA) is shaped in such a way that it may be comfortably grasped both with the rightward-pointing left hand (LHB) as well as with the leftward-pointing right hand (RHB), wherein from the outset the button (TS) is in comfortable reach of the left thumb (LDB) or the right thumb (RDB) of the respective hand being used.

6. The pivot arm stand for digital microscopes according to claim 2,
wherein the joint part (GT) includes an active lever arm (H) relative to the rotation axis (DA), at which the tractive forces created as a result of a first tension spring (ZFA) and a second tension spring (ZFB), each attached with their other end to the stand (SST), are coupled into the joint part (GT) via the arrangement of the tensions springs (ZFA, ZFB) on the stand (SST) in such a way that the torque to be applied by the user for setting the pivot angle (w), which is determined by the instantaneous Z-position of a motorized upper Z-guide (ZMO) and the weight force of the simultaneously pivoted parts as a function of the instantaneous pivot angle (w) and the position of the center of gravity (S), and by the frictional torque created by the mounting, is reduced by the tension springs (ZFA, ZFB) in the entire pivot angle range independently of the instantaneous Z-position of the upper motorized Z-guide (ZMO), to thereby facilitate operation by the user, and
wherein the torques present in the area of the vertical setting of the pivot arm (SA) created by the first tension spring (ZFA) and the second tension spring (ZFB), and which support the movement in the direction of the vertical setting, contribute to locating of the vertical setting of the pivot arm (SA).

7. The pivot arm stand for digital microscopes according to claim 6,
wherein the tractive forces created by a first tension spring (ZFA) and the second tension spring (ZFB) are coupled into the joint part (GT) via the arrangement of tension springs on the stand (SST) in such a way that the torque (w) to be applied by the user for setting the pivot angle (w), which is determined by the position of the center of gravity (S) as a function of the instantaneous pivot angle (w) and the instantaneous Z-position of the motorized upper Z-guide (ZMO) and by the weight force of the simultaneously pivoted parts acting there, and by the frictional torques created by the mounting are fully compensated or overcompensated by the tension springs (ZFA, ZFB) over the entire pivot angle range between a bottom-most Z-position (Z1) of the upper motorized Z-guide (ZMO) and at least up to a marginal Z-position (Z2), in which a danger exists of tilting over an edge (KN) when falling short of the negative marginal pivot angle (GWN) or over the edge (KP) when the marginal pivot angle (GWP) is exceeded, the overcompensation resulting in stronger return torques, which makes it easier for the user to return the pivot arm (SA) to the vertical position.

8. The pivot arm stand for digital microscopes according to claim 1,
wherein the rotation axis (DA) of the pivot arm (SA) is defined by at least two low-friction roller bearings (VK) and (HK), and a sufficiently smooth locking arrangement having a discernible lock-capturing range between the joint part (GT) and the fixed bearing block (LB),
wherein the active return forces which result with minimal frictional losses from the locking arrangement with the spring-loading forces, for the mounting and locking assembly, lead to locating of a discernible and reproducible locking position for the vertical alignment of the pivot arm (SA).

9. The pivot arm stand for digital microscopes according to claim 1,
wherein the locking assembly comprises a fixed locking lever (RL), which is mounted for pivotal movement about a rotation axis (DR) in the joint part (GT) and supports a locking ball bearing (RK) which has a rotation axis (DK), and of a locking segment (RS) having an outer surface (MF) on which the locking ball bearing (RK) rolls and a lock geometry (RG) in the outer surface (MF),
wherein the locking lever (RL) is pressed by at least one tension spring or compression spring by the three compression springs (DF1), (DF2) and (DF3), against the outer surface (MF),
wherein the lock geometry (RG) is designed such that the locking ball bearing (RK) is drawn into a stable locking position corresponding to a vertical alignment of the pivot arm (SA) from the start of the capture range, which begins before reaching the vertical alignment of the pivot arm (SA), the stable locking position also providing reproducibility of the vertical alignment of the pivot arm (SA).

10. The pivot arm stand for digital microscopes according to claim 1,
wherein the ergonomically shaped section (EB) of the pivot arm (SA) is provided with a handle surface (GO) in the form of a soft-touch surface of contrasting color at the upper end of the pivot arm (SA).

11. The pivot arm stand for digital microscopes according claim 6,
wherein the instantaneous Z-coordinate of the motorized upper Z-guide (ZMO) is retrievable when the button (TS) is pressed and the pivotal movement is permitted only when the allowable marginal Z-position (Z2) of the motorized upper Z-guide (ZMO) is not exceeded.

12. The pivot arm stand for digital microscopes according to claim 7,
wherein the instantaneous Z-coordinate of the motorized upper Z-guide (ZMO) is retrievable when the button (TS) is pressed,
wherein the angular position of the pivot arm (SA) is determined by a measuring system and the pivotal movement is limited to a permissible pivot angle range as a function of the instantaneous Z-coordinate of the motorized upper Z-guide (ZMO), and
wherein a blocking of the magnetic brake is not permitted outside the permissible pivot angle range and, when combined with the tension spring assembly, a sufficiently strong return force is available for the return to the permissible pivot angle range such that a release of the button (TS) outside the permissible pivot angle range results in a pivot angle (w) that is set within the pivot angle range.

13. The pivot arm stand for digital microscopes according to claim 12,
wherein the departure from the permissible pivot angle range is indicated by at least one of an acoustic signal and a warning on the control and display unit.

14. The pivot arm stand for digital microscopes according to claim 9,
wherein the outer surface (MF) outside the lock geometry is curved in such a way that the locking ball bearing (RK) is consistently the same distance away from the rotation axis (DA), as a result of which the contact force of the locking ball bearing (RK) against the outer surface (MF) of the locking segment (RS) consistently remains constant regardless of the pivot angle (w).

15. The pivot arm stand for digital microscopes according to claim 9,
wherein the outer surface (MF) outside the lock geometry is curved in such a way that the distance between the locking ball (RK) bearing and the rotation axis (DA) is variable depending on the pivot angle (w), as a result of which the contact force of the locking ball bearing (RK) against the outer surface (MF) of the locking segment (RS) is also dependent on the pivot angle (w), the curvature being selectable such that the torque curves from the tension spring assembly are corrected to produce the desired torque curve as a function of the pivot angle (w).

16. The pivot arm stand for digital microscopes according to claim 4,
wherein the upper end of the pivot arm (SA) is rotationally symmetrically designed about the vertical center axis in the vertical setting, thereby creating an ergonomically shaped section (EB) which may be comfortably grasped both with the rightward-pointing left hand (LHB) and with the leftward-pointing right hand (RHB), the button (TS) situated on the upper end face of the pivot arm (SA) in this arrangement being in comfortable reach of the left thumb (LDB) or right thumb (RDB) of the respective hand being used.
